(19) United States
(12) Patent Application Publication
(10) Pub. No.: US 2005/0237318 A1
(43) Pub. Date: Oct. 27, 2005

(54) Device that generates correction value for non-uniformity of display

(76) Inventors: Masutaka Inoue, Nayagawa City (JP); Yukio Mori, Hirakata City (JP); Atsuhiro Yamashita, Osaka City (JP); Susumu Tanase, Kadoma City (JP); Atsufumi Kinoshita, Osaka City (JP)

Correspondence Address: MCDERMOTT WILL & EMERY LLP, 600 13TH STREET, N.W., WASHINGTON, DC, 20005-3096, US

(21) Appl. No.: 11/092,982

(22) Filed: Mar. 30, 2005

(30) Foreign Application Priority Data
Mar. 30, 2004 (JP) 2004-98902
Feb. 28, 2005 (JP) 2005-52438

(51) Int. Cl. G09G 3/10

(52) U.S. Cl. 345/207

(57) ABSTRACT

There are provided image taking means for taking an image displayed on a display panel on which the non-uniformity of the display is to be corrected, and correction value calculating means for generating the correction value for the non-uniformity of the display with respect to each luminescence area on the display panel based on the image taken by the image taking means in a state where all pixels on the display panel produce luminescence.

### BACKGROUND OF THE INVENTION

1. Field of the Invention

The present invention relates to a device that generates a correction value for non-uniformity of display in a display panel such as an organic EL panel, an inorganic EL panel, PDP and the like in which there is variation in luminous efficiency characteristic of each pixel, or for non-uniformity of display in a display panel such as an LCD panel in which there is variation in transmission characteristic.

2. Description of the Related Art

It is difficult to make luminance characteristic uniform over the entire region on the display panel such as the organic EL panel at present, so that non-uniformity of display is a big problem. It is considered that the non-uniformity of the display is caused by variation in film thickness of a luminous layer in a manufacturing step of the display panel.

### SUMMARY OF THE INVENTION

It is an object of the present invention to provide a device that easily generates a correction value for non-uniformity of display.

A first device that generates a correction value for non-uniformity of display according to the present invention is characterized by comprising image taking means for taking an image displayed on a display panel on which the non-uniformity of the display is to be corrected and correction value calculating means for generating the correction value for the non-uniformity of the display with respect to each luminescence area on the display panel based on the image taken by the image taking means in a state all pixels on the display panel produce luminescence.

For example, the correction value calculating means comprises first means for extracting each luminescence area on the display panel based on the image taken by the image taking means, second means for calculating a luminance value of the extracted each luminescence area based on the image taken by the image taking means, and third means for calculating the correction value for the non-uniformity of the display with respect to each luminescence area based on the calculated luminance value of each luminescence area.

For example, the third means sets one luminescence area as a reference luminescence area and calculates the correction value for the non-uniformity of the display of each luminescence area from a value corresponding to a difference in luminescence start tone level between the luminescence area and the reference luminescence area, based on a luminous efficiency characteristic of any luminescence area and the luminance value of each luminescence area calculated by the second means.

For example, the image taking means is implemented by a digital camera and the correction value calculating means is implemented by a PC.

According to a second device that generates a correction value for non-uniformity of display is characterized by comprising image taking means for taking an image displayed on a display panel on which the non-uniformity of the display is to be corrected, in a state where all pixels on the display panel are divided into a plurality of groups and only the pixels belonging to one group produce luminescence with respect to each group, luminance value calculating means for calculating a luminance value of each luminescence area corresponding to a pixel belonging to the group, based on an image taken by the image taking means from the image on the display panel, and correction value calculating means for generating the correction value for the non-uniformity of the display with respect to each pixel on the display panel, based on the luminance value of the luminescence area corresponding to each pixel on the display panel which is calculated by the luminance value calculating means.

For example, the luminance value calculating means comprises first means for extracting the luminescence area corresponding to each pixel belonging to each of the groups, based on the image taken by the image taking means in the state where only the pixels belonging to one group produce luminescence with respect to each group, and second means for calculating the luminance value in the luminescence area corresponding to each pixel belonging to the group extracted by the first means, based on the image taken by the image taking means in the state where only the pixels belonging to the group produce luminescence.

For example, the correction value calculating means sets one luminescence area as a reference luminescence area and calculates the correction value for the non-uniformity of the display of each luminescence area from a value corresponding to a difference in luminescence start tone level between the luminescence area and the reference luminescence area, based on a luminous efficiency characteristic of any luminescence area and the luminance value of the luminescence area corresponding to each pixel on the display panel, which is calculated by the luminance value calculating means.

For example, the image taking means is implemented by a digital camera, and the luminance value calculating means and the correction value calculating means are implemented by a PC.

In the second device that generates the correction value for the non-uniformity of the display, for example, all of the pixels on the display panel are divided into a first group comprising odd-numbered pixels in odd lines and even-numbered pixels in even lines, and a second group comprising even-numbered pixels in odd lines and odd-numbered pixels in even lines.

A third device that generates a correction value for non-uniformity of display is characterized by comprising image taking means for taking an image displayed on a display panel on which the non-uniformity of the display is to be corrected, and correction value calculating means for calculating the correction value for the non-uniformity of the display with respect to each luminescence area on the display panel, by dividing the entire region on the display panel into a plurality of image pickup areas so that parts of the adjacent image pickup arrears overlap each other and taking images on those areas by the image taking means, based on the image of each image pickup area, in a state all of the pixels on the display panel produce luminescence.

For example, the correction value calculating means comprises first means for calculating a luminance value of each luminescence area on the display panel in the image pickup area based on the image of the image pickup area with respect to each image pickup area, second means for calculating an average luminance value of each luminescence area in the image pickup area with respect to each image pickup area, third means for correcting variation in luminance of each luminescence area between the image pickup areas, based on the average luminance of each luminescence area in each image pickup area calculated by the second means, fourth means for calculating a luminance value of each luminescence area in a part of the image pickup area overlapping the adjacent area by a weighted addition method, based on the luminance value of each luminescence area of each image pickup area corrected by the third means, fifth means for finding each luminance value on the display panel by setting the luminance value corresponding to the luminescence area corrected by the third means as the luminance value of the luminescence area in a region which does not overlap the adjacent image pickup area, and by setting the luminance value calculated by the fourth means as the luminance value of the luminescence area in the region which overlaps the adjacent image pickup area, and sixth means for calculating the correction value of the non-uniformity of the display of each luminescence area based on the luminance value of the luminescence area calculated by the fifth means.

For example, the sixth means sets one luminescence area as a reference luminescence area and calculates the correction value for the non-uniformity of the display of each luminescence area from a value corresponding to a difference in luminescence start tone level between the luminescence area and the reference luminescence area, based on a luminous efficiency characteristic of any luminescence area and the luminance value of each luminescence area calculated by the fifth means.

For example, the image taking means is implemented by a digital camera and the correction value calculating means is implemented by a PC.

A fourth device that generates a correction value for non-uniformity of display is characterized by comprising image taking means for taking an image displayed on a display panel on which the non-uniformity of the display is to be corrected, first means for performing an operation in which luminescence is produced from all pixels on the display panel uniformly at a certain tone (luminance measuring tone) and the image displayed on the display panel is taken by the image taking means, with respect to each of plural kinds of luminescence measuring tones, second means for calculating a luminance value of each luminescence area on the display panel based on the image taken at each luminance measuring tone, third means for calculating the correction value for the non-uniformity of the display with respect to each luminescence area taken at each luminance measuring tone, based on the luminance value of each luminescence area on the display panel calculated by the second means taken at each luminance measuring tone, and fourth means for calculating a parameter to calculate the correction value of the non-uniformity of the display for an input tone with respect to each luminescence area, based on the correction value for the non-uniformity of the display of each luminescence area calculated by the third means taken at each luminance measuring tone.

For example, the third means sets one luminescence area as a reference luminescence area and calculates the correction value for the non-uniformity of the display with respect to each luminescence area from a shift amount to shift the input tone of each luminescence area so that the luminance value of each luminescence area may become equal to the luminance value of the reference luminescence area at each luminance measuring tone, based on a luminous efficiency characteristic of any luminescence area and the luminance value of each luminescence area calculated by the second means.

For example, the image taking means is implemented by a digital camera and the first to fourth means are implemented by a PC.

### BRIEF DESCRIPTION OF THE DRAWINGS

FIG. 1 is a graph showing characteristics between an input tone level and luminance of pixels “a” and “b”;

FIG. 2 is a graph showing a characteristic between an input video signal level and luminance when the characteristic between the input video signal level and the luminance of the pixel “b” is shifted to the left by ΔVth by adding a value ΔVth to an input video signal of the pixel “b”;

FIG. 3 is a graph showing characteristics between input video signal levels and luminance of pixels “a”, “b” and “c”;

FIG. 4 is a graph showing a characteristic between an input video signal level and luminance when a step width changing operation is performed and then a shift operation is performed for the input video signal;

FIG. 5 is a block diagram showing a constitution of a device that generates a correction value for non-uniformity of display;

FIG. 6 is a schematic view showing a size of a pixel 101 of a digital camera 1 and a size of a pixel 102 of a display panel 11;

FIG. 7 is a flowchart showing operation procedures to generate a correction parameter;

FIG. 8 is a schematic view showing an image example taken by the digital camera;

FIG. 9 is a flowchart showing operation procedures to calculate the correction parameter of each luminescence area at step S6 in FIG. 7;

FIG. 10 is a schematic view showing luminescence areas when it is assumed that there are six luminescence areas on the display panel;

FIG. 11 is a schematic view showing luminance values L_{A} to L_{F} of luminescence areas A to F;

FIG. 12 is a block diagram showing a constitution of a drive circuit (circuit that corrects non-uniformity of display) 12 in a display 10;

FIG. 13 is a flowchart showing operation procedures to generate a generation pattern of a luminescence area detail mask;

FIG. 14 is a flowchart showing operation procedures when the correction parameter is generated using the luminescence area detail mask;

FIGS. 15a and 15b are schematic views showing two kinds of patterns in which all of the pixels on the display panel 11 are divided into two groups;

FIG. 16 is a graph showing characteristics between voltage and current of transistors of the pixels “a” and “b”;

FIG. 17 is a schematic view showing that when a correction amount Vth is calculated by a lower white side reference voltage VR1 and then the white side reference voltage is increased to VR2 in order to increase adjustment luminance, the correction amount Vth is also increased after digital-analog conversion by a DAC 33;

FIG. 18 is a schematic view to explain a case where the entire region on the display panel 11 is divided into two, right and left image pickup areas A and B and images thereof are taken;

FIG. 19 is a flow chart showing operation procedures in which the entire region on the display panel 11 is divided into the two, right and left image pickup areas A and B and images thereof are taken to generate a correction parameter from their images taken;

FIG. 20 is a graph showing weighted addition factors KA(x) and KB(x);

FIG. 21 is a graph showing a correction parameter which changes depending on an input tone level;

FIG. 22 is a flowchart showing operation procedures to find a correction factor to calculate the correction parameter Vth which changes depending on the input tone level; and

FIG. 23 is a block diagram showing a constitution of the drive circuit (circuit that corrects non-uniformity of display) 12 in the display 10.

### DESCRIPTION OF THE PREFERRED EMBODIMENTS

Embodiments of the present invention will be described with reference to the drawings hereinafter.

### [A] Embodiment 1

[1] Description of a Principle of a Correction Method of Non-Uniformity of Display

It is assumed that an input video signal after A/D conversion is 8 bits in the following description. In addition, it is assumed that a value designating a voltage applied to a display panel at 256 levels is referred to as an input tone level. Furthermore, a level of the input video signal after the A/D conversion is referred to as an input video signal level and this is used in distinction from the input tone level.

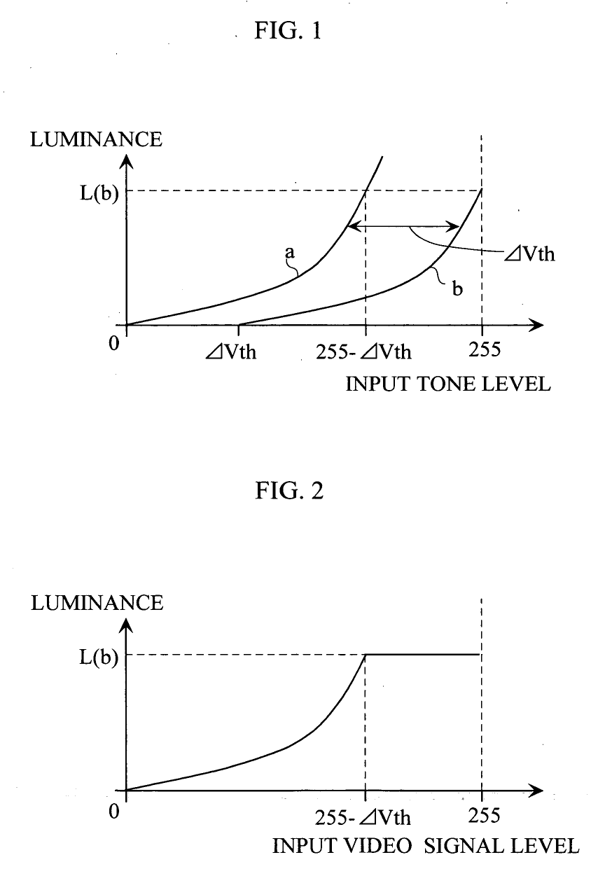

Characteristics between an input tone level and luminance of different pixels “a” and “b” on the display panel are shown as “a” and “b” in FIG. 1. Thus, when a voltage Vth at the start of luminescence in the pixel is different from the other, the non-uniformity of the display is generated.

Since a luminous efficiency characteristic of the pixel is almost the same as the other, when the characteristic between the input video signal level and the luminance of the pixel is shifted horizontally by a value corresponding to a difference ΔVth in tone level Vth at the start of luminescence between the two pixels, the characteristic between the input video signal level and the luminance of the pixel “a” becomes equal to that of the pixel “b”. As a result, the non-uniformity of the display can be corrected.

For example, referring to FIG. 1, the characteristic between the input video signal level and the luminance of the pixel “a” becomes the same as that of the pixel “b” by applying a value which is provided by adding ΔVth to the input video signal of the pixel “b”, to the pixel “b”, to shift the characteristic between the input video signal level and the luminance of the pixel “b” by ΔVth to the left. The characteristic between the input video signal level and the luminance in this case is shown in FIG. 2.

However, since the display panel cannot display luminance higher than luminance corresponding to the input tone level “255”, it is necessary to set the luminance when the input tone of the darkest pixel (the pixel whose tone level Vth at the start of luminescence is highest) is “255” as an upper limit. In the above example, as shown in FIGS. 1 and 2, when the correction is performed, it is necessary to set the luminance L (b) as the upper limit when the input tone of the darkest pixel “b” is “255”. As a result, when the input video signal level is higher than (255−ΔVth), the luminance becomes the constant value (L(b)), so that the expression tone is reduced by ΔVth.

Thus, the input video signal levels 0 to 255 are evenly allotted to the number of the expression tones after the input video signal of the darkest pixel is shifted. When ΔVth=30 in the above example, the number of the expression tones after the input video signal of the darkest pixel is shifted is 226 (0 to 255). Thus, the level range 0 to 255 of the input video signal of each pixel is evenly allotted to 0 to 255 and then the sift operation is performed.

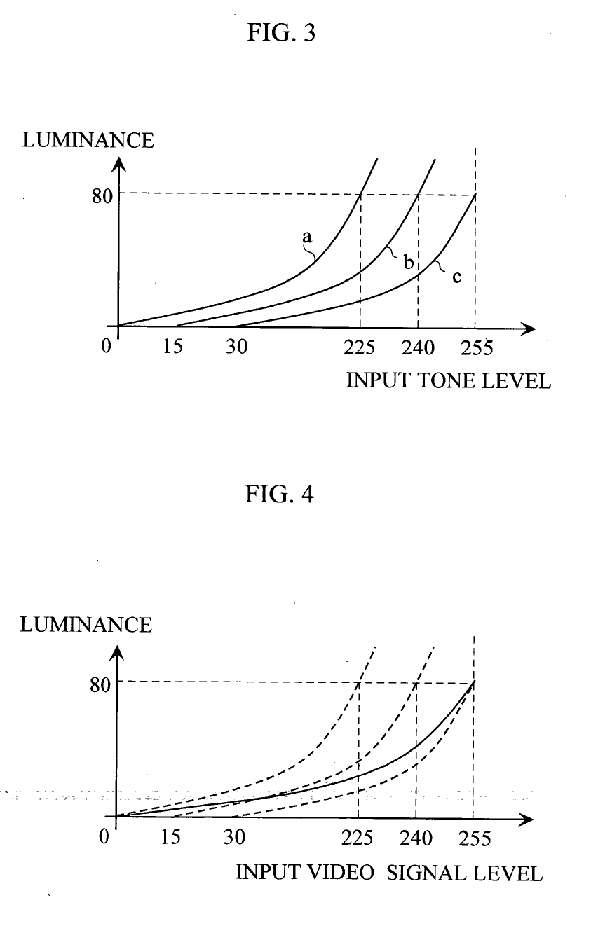

For example, FIG. 3 shows characteristics between the input tone level and the luminance of the different pixels “a”, “b” and “c” on the display panel. It is assumed that when the characteristic “a” is a baseline, a shift amount of the input video signal of the pixel “b” is determined at 15 and a shift amount of the input video signal of the pixel “c” is determined at 30.

In this case, since the shift amount of the input signal of the pixel “c” is largest, the level range 0 to 255 of the input video signal of each pixel is evenly allotted to the number 226 (0 to 255) of the expression tones after the input video signal of the pixel “c” is shifted.

That is, the input video signal is multiplied by (255—shift amount of the darkest pixel)/255 so that the range of the input video signal level after the multiplication becomes 0 to 225. Thus, a step width of the input video signal is changed. This operation is referred to as the step width changing operation of the input video signal. Then, the multiplied signal is shifted.

Since the shift amount of the pixel “a” is 0, the range of the shifted input tone level is 0 to 255. Meanwhile, since the sift amount of the pixel “b” is 15, the range of the input tone level after the shift operation is 15 to 240. According to the pixel “c”, since its shift amount is 30, the range of the input tone level after the shift operation is 30 to 255.

Therefore, the luminance characteristics of the pixels “a”, “b” and “c” at the input video signal levels (0 to 255) are shown by solid lines in FIG. 4. As a result, the non-uniformity of the display can be eliminated and tone lowering on the high tone side can be reduced as compared with FIG. 2. The above shift amount is referred to as a correction parameter hereinafter. According to this embodiment, the correction parameter (correction value for the non-uniformity of the display) can be found every luminescence area of the pixel.

[2] Description of a Method of Generating the Correction Parameter

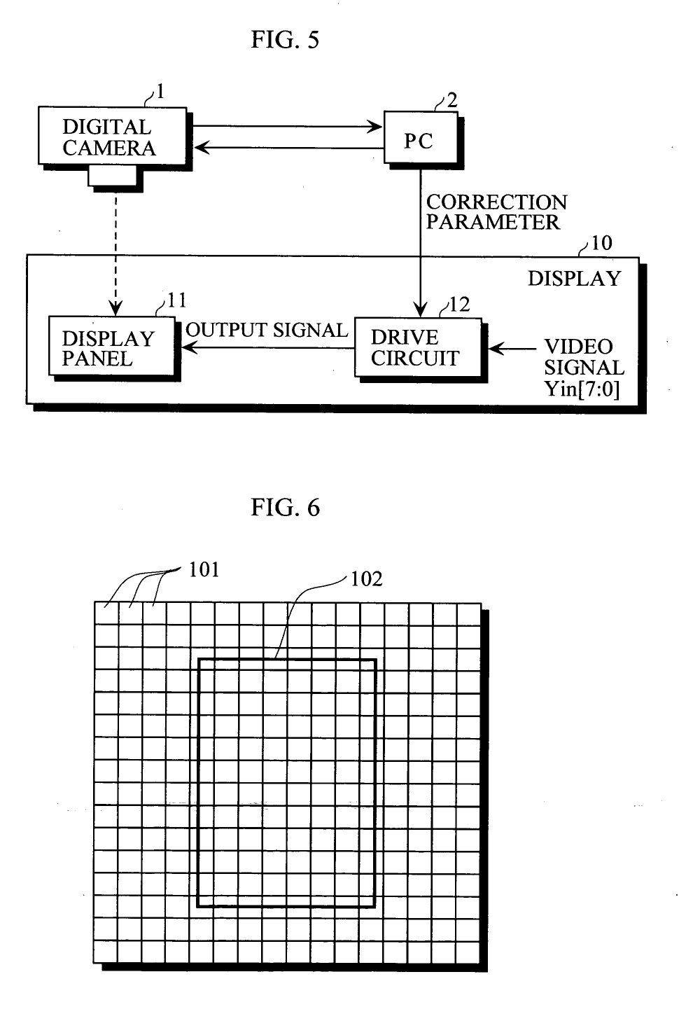

FIG. 5 shows a constitution of a device that generates the correction parameter to correct the non-uniformity of the display on the display panel (the device that generates the correction value for the non-uniformity of the display).

A display 10 comprises a display panel 11, a drive circuit (circuit that corrects the non-uniformity of the display) 12 and the like. The device that generates the correction value for the non-uniformity of the display comprises a digital camera 1 to take an image of the display panel 11, and a PC 2 to generate the correction parameter to correct the non-uniformity of the display on the display panel 11 based on the image taken by the digital camera 1.

As the digital camera 1, the one which has sufficiently large number of pixels as compared with the number of pixels of the display panel 11 is used. That is, as shown in FIG. 6, a size of a pixel 101 of the digital camera 1 is sufficiently smaller than a pixel of the display panel 11 shown by a thickly outlined frame 102 in FIG. 6.

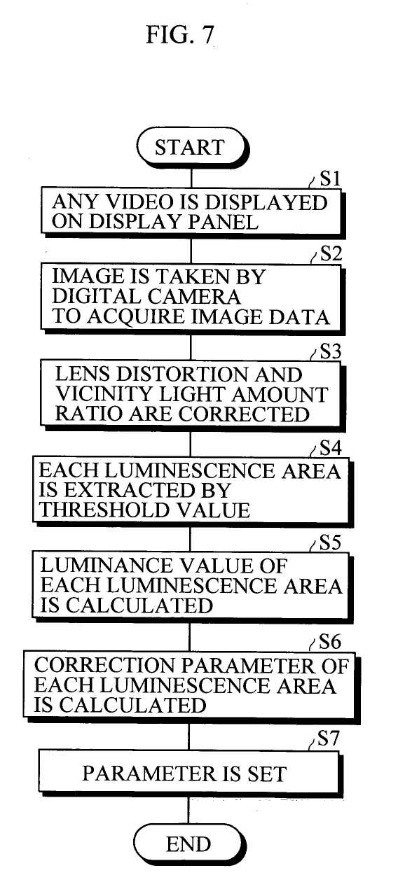

FIG. 7 shows operation procedures to generate the correction parameter.

First, a certain input video signal whose input video signal level to each pixel of the display panel 11 is the same is input to the display 10 and an image is displayed on the display panel 11 (step S1). In this case, the PC 2 may send the input video signal to the display 10.

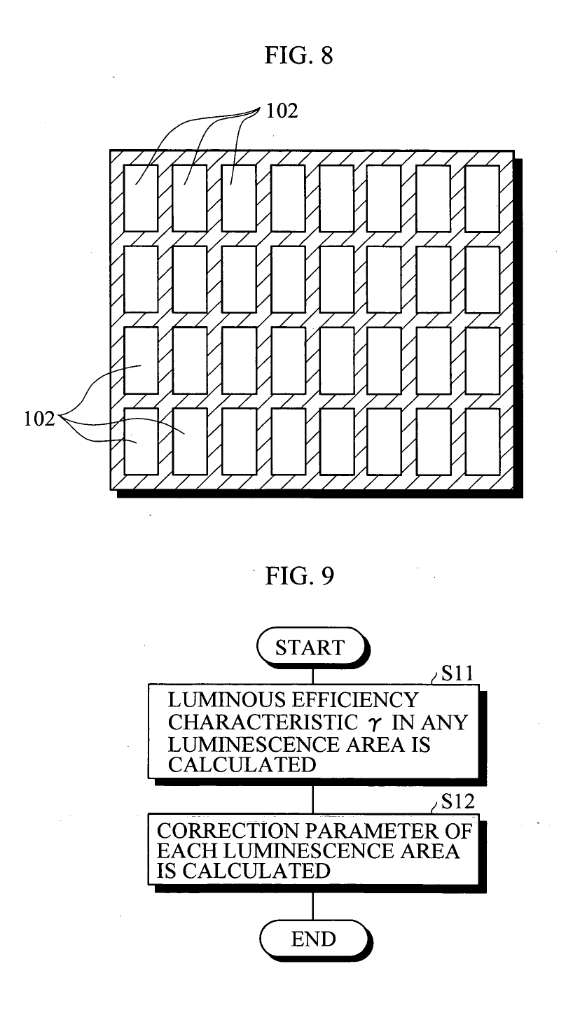

The image displayed on the display panel 11 is taken by the digital camera 1, so that the PC 2 can acquire the image data of the digital camera 1 (step S2). FIG. 8 shows an example of the acquired image. In FIG. 8, reference numeral 102 designates a luminescence area of the pixel on the display panel 11.

The PC 2 performs lens distortion correction and lens vicinity light amount ratio correction to the acquired data (image data) (step S3).

The PC 2 extracts each luminescence area (pixel) on the display panel 11 by binarizing the corrected image data using a threshold value (step S4).

The PC 2 calculates a luminance value of each luminescence area (step S5). As the luminance value of each luminescence area, a signal maximum value in the luminescence area, a signal integration value in the luminescence area, a signal average value in the luminescence area and the like are used. As the luminance value of each luminescence area, a signal integration value or signal average value in a central region of the luminescence area or in a region around the signal maximum value may be used.

The PC 2 calculates the correction parameter corresponding to each luminescence area based on the luminance value of each luminescence area (step S6). This operation will be described in detail below.

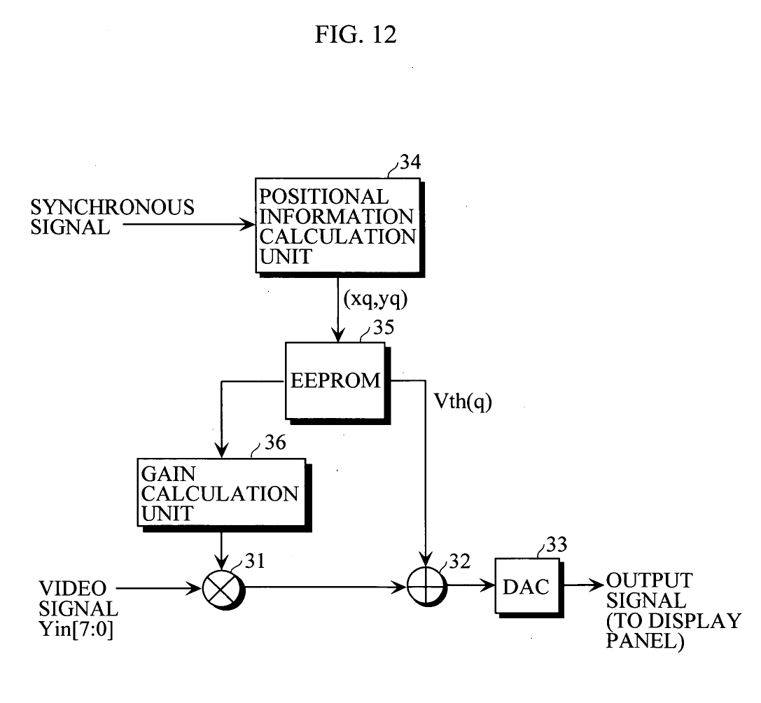

The PC 2 sets the obtained correction parameter of each luminescence area in the drive circuit 12 in the display 10 (step S7). That is, the correction parameter Vth of each luminescence area and a maximum value Vth_{MAX} of the correction parameter are stored in an EEPROM 35 (refer to FIG. 12) in the drive circuit 12.

FIG. 9 shows calculation procedures of the correction parameter of each luminescence area at step S6.

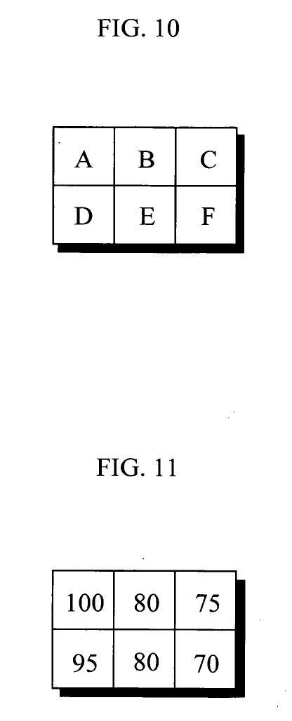

Here, as shown in FIG. 10, a description will be made in a case where there are 6 luminescence areas on the display panel 11, for convenience of the description. It is assumed that the luminance values of the luminescence areas A to F at a predetermined tone level (referred to as the luminance measuring tone level hereinafter and it is set at “127” in this example) have been provided at the above steps S1 to S5. That is, it is assumed that the input video signal at a level corresponding to the input tone 127 has been inputted to each pixel on the display panel 11 at the step S1.

According to this example, the luminance values L_{A} to L_{F} of the luminescence areas A to F provided at the steps S1 to S5 are set as shown in FIG. 11. That is, L_{A}=100, L_{B}=80, L_{C}=75, L_{D}=95, L_{E}=80, and L_{F}=70. The brightest luminescence area (brightest area) is the luminescence area A and the darkest luminescence area (darkest area) is the luminescence area F.

Luminous efficiency characteristic y in any luminescence area (reference luminescence area) in the luminescence areas A to F is calculated (step S11). For example, the luminous efficiency characteristic γ in the luminescence area A is calculated. At this time, in the luminescence area A, the luminance values in the plurality of tones may be measured to calculate the γ value or a predetermined known y value may be used.

When the luminance values in the plurality of tones are measured to calculate the γ in the luminescence area A, the value γ is calculated every tone based on the following equation (1). Thus, an average value of the plurality of values γ is set at the value γ of the luminescence area A, for example.

$$L = 100 \times {( \frac{I}{127} )}^{γ} \qquad ( 1 )$$

In the above equation (1), reference numeral 127 designates an example of the luminance measuring tone level, reference numeral 100 designates the luminance at the luminance measuring tone level, reference character L designates the luminance, and reference character I designates the input tone.

Then, the correction parameters for the luminescence areas A to F are calculated (step S12).

When Vth (i), Data (i), Level and y are defined as follows, the correction parameters of the luminescence areas A to F are calculated based on the following equation (2).
Vth (i): a shift amount (correction parameter) of the luminescence area i from a reference luminescence area ω
Data (i): the luminance value in the luminescence area i at the luminance measuring tone level
Data (ω): the luminance value in the reference luminescence area ω at the luminance measuring tone level
Level: luminance measuring tone level
γ: luminous efficiency characteristic of the display panel (constant value)

$$Data ( i ) = Data ( ω ) \times {( \frac{Level - Vth ( i )}{Level} )}^{γ} \qquad ( 2 )$$

Here, the brightest area (luminescence area whose measured luminance at the luminance measuring tone level is highest) A is set at the reference luminescence area ω. When it is assumed that the reference luminescence area is the luminescence area A, the luminance measuring tone level is “127”, γ=2, and the luminance values in the luminescence areas A to F at the luminance measuring tone level are set as shown in FIG. 11, the following equations (3) to (8) for the luminescence areas A to F are provided from the above equation (2).

$$\begin{matrix}100 = 100 \times {( \frac{127 - Vth ( A )}{127} )}^{2} & ( 3 ) \\ 80 = 100 \times {( \frac{127 - Vth ( B )}{127} )}^{2} & ( 4 ) \\ 75 = 100 \times {( \frac{127 - Vth ( C )}{127} )}^{2} & ( 5 ) \\ 95 = 100 \times {( \frac{127 - Vth ( D )}{127} )}^{2} & ( 6 ) \\ 80 = 100 \times {( \frac{127 - Vth ( E )}{127} )}^{2} & ( 7 ) \\ 70 = 100 \times {( \frac{127 - Vth ( F )}{127} )}^{2} & ( 8 )\end{matrix}$$

The shift amounts Vth (i) in the luminescence areas A to F from the reference luminescence area A are calculated according to the above equations (3) to (8). The calculation results are as follows.
Vth (A)=0
Vth (B)=13.4
Vth (C)=17.0
Vth (D)=3.2
Vth (E)=13.4
Vth (F)=20.7
   [3] Description of a Constitution of the Drive Circuit (Circuit that Corrects the Non-Uniformity of the Display) 12 in the Display 10

FIG. 12 shows a constitution of the drive circuit (circuit that corrects the non-uniformity of the display) 12 in the display 10.

The correction parameter Vth of each of the luminescence areas A to F is stored in the EEPROM 35. In addition, the maximum value of the correction parameter is stored in the EEPROM 35 as Vth_{MAX}. The maximum value of the correction parameter is a correction parameter for the darkest area, that is, Vth_{MAX}=Vth (F)=20.7 in the above example.

The input video signal Yin is sent to the display panel (Organic EL panel) 11 through a multiplier 31 to perform the step width changing operation to the input video signal, an adder 32 to perform the shift operation to an output of the multiplier 32 and a DAC 33 to convert an output of the adder 32 to an analog signal.

The maximum value Vth_{MAX} of the correction parameter is sent from the EEPROM 35 to a gain calculation unit 36. The gain calculation unit 36 calculates a gain based on the following equation (9) and applies a calculated gain to the multiplier 31.

$$gain = \frac{255 - {Vth}_{MAX}}{255} \qquad ( 9 )$$

A synchronous signal contained in the input video signal is sent to a positional information calculation unit 34. The positional information calculation unit 34 calculates the positional information (xq, yq) of the video signal inputted at present (video signal of a target pixel) based on the synchronous signal.

The positional information (xq, yq) of the target pixel calculated by the positional information calculation unit 34 is applied to the EEPROM 35. The correction parameter Vth (q) corresponding to the luminescence area (target pixel) shown by the positional information (xq, yq) is read from the EEPROM 35 and sent to the adder 32.

The multiplier 31 multiplies the input video signal Yin by the gain. An output of the multiplier 31 is sent to the adder 32. The adder 32 adds the shift amount Vth (q) to the output of the multiplier 31. An output of the adder 32 is sent to the DAC 33 and converted to the analog signal Yout and sent to the display panel 11.

According to the embodiment 1, the correction parameter can be generated by the device that generates the correction value for the non-uniformity of the display which comprises the digital camera 1 and the PC 2, for the plurality of display panels having the same specification.

### [B] Embodiment 2

According to the embodiment 1, it is necessary to extract each luminescence area using the threshold value every time when the correction parameter is generated by the device that generates the correction value for the non-uniformity of the display for the plurality of display panels having the same specification as shown in the step S4 in FIG. 7. Thus, according to an embodiment 2, a mask corresponding to a pattern of each luminescence area of the display panel (luminescence area detail mask) is created first, and each luminescence area on the display panel is extracted using that mask, so that the luminescence area can be further easily extracted.

In addition, a device that generates the correction value for the non-uniformity of the display also comprises a digital camera 1 and a PC 2 in the embodiment 2 as shown in FIG. 5.

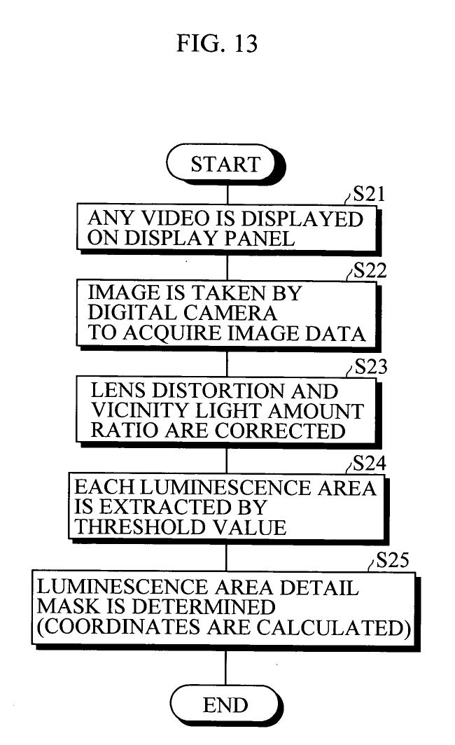

FIG. 13 shows operation procedures for a generation pattern of the luminescence area detail mask.

First, a certain input video signal whose input video signal level to each pixel of a display panel 11 is the same is input to a display 10 and an image is displayed on the display panel 11 (step S21).

The image displayed on the display panel 11 is taken by the digital camera 1, so that the PC 2 can acquire the image data of the digital camera 1 (step S22).

The PC 2 performs lens distortion correction and lens vicinity light amount ratio correction to the acquired data (image data) (step S23).

The PC 2 extracts each luminescence area (pixel) on the display panel 11 by binarizing the corrected image data using a threshold value (step S24).

Then, the PC 2 generates a mask corresponding to a pattern of each luminescence area (luminescence area detail mask) (step S25). For example, the luminescence area detail mask is generated as collection of center coordinates of the luminescence area.

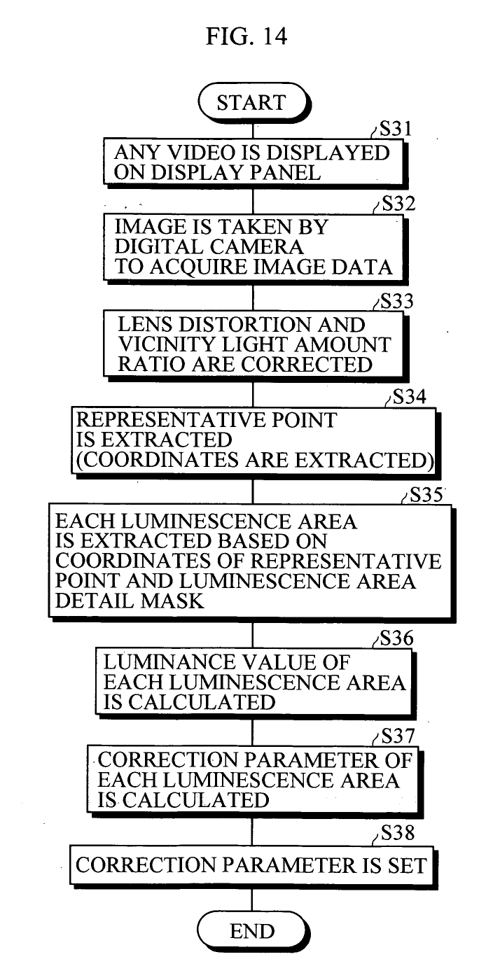

FIG. 14 shows operation procedures when the correction parameter is generated using the luminescence area detail mask.

First, a certain input video signal whose input video signal level to each pixel of a display panel 11 is the same is input to the display 10 and an image is displayed on the display panel 11 (step S31).

The image displayed on the display panel 11 is taken by the digital camera 1, so that the PC 2 can acquire the image data of the digital camera 1 (step S32).

The PC 2 performs lens distortion correction and lens vicinity light amount ratio correction to the acquired data (image data) (step S33).

The PC 2 extracts coordinates of representative points in the luminescence area (pixel) on the display panel 11 by binarizing the corrected image data using a threshold value (step S34). More specifically, center coordinates of luminescence area at four corners on the display panel 11 are extracted as the coordinates of the representative points.

Then, the PC 2 extracts each luminescence area using the coordinates of the representative points provided at the step S34 and the luminescence area detail mask (step S35). More specifically, each luminescence area is extracted from the image taken this time by converting the center coordinates of each luminescence area of the luminescence area detail mask such that the center coordinates of the luminescence area at four corners of the luminescence area detail mask may coincide with the center coordinates of the luminescence area at the four corners provided at the step S34.

The PC 2 calculates a luminance value of each luminescence area (step S36). As the luminance value of each luminescence area, a signal maximum value in the luminescence area, a signal integration value in the luminescence area, a signal average value in the luminescence area and the like are used.

The PC 2 calculates the correction parameter corresponding to each luminescence area based on the luminance value of each luminescence area (step S37).

The PC 2 sets the obtained correction parameter of each luminescence area in a drive circuit 12 in the display 10 (step S38).

According to the method of generating the correction parameter (refer to FIG. 7) in the embodiment 1, luminescence is produced from all of the pixels on the display panel 11 and the luminescence areas of all of the pixels are extracted at a time and the luminance value of each luminescence area is calculated as shown in FIG. 8.

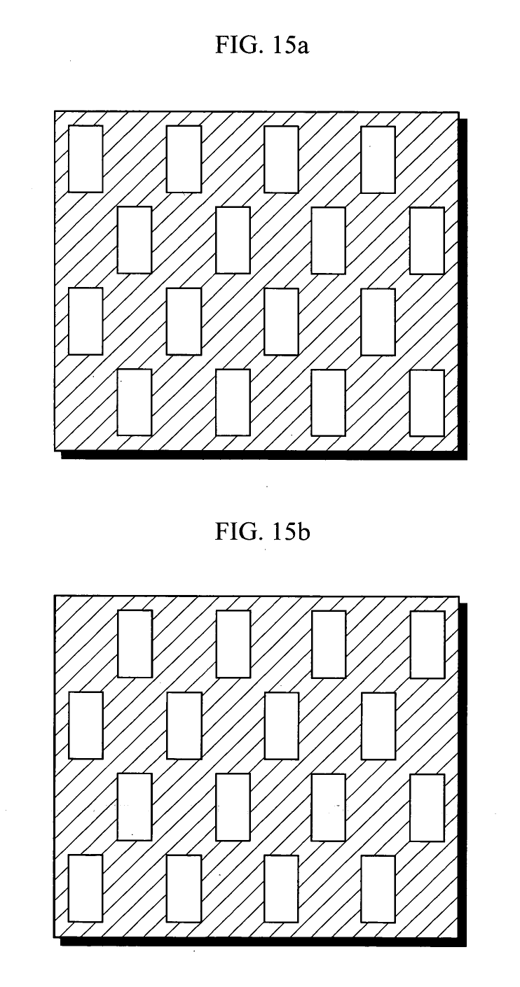

Meanwhile, as shown in FIGS. 15a and 15b, two kinds of patterns are generated by dividing all pixels on the display panel 11 into two groups and the luminance value of the pixel may be calculated every pattern by producing luminescence from pixels in each pattern.

The pattern (first pattern) shown in FIG. 15a comprises the group of odd-numbered pixels in odd lines and even-numbered pixels in even lines. The pattern (second pattern) shown in FIG. 15b comprises the group of even-numbered pixels in the odd lines and odd-numbered pixels in the even lines.

First, luminescence are produced from the pixels in the first pattern shown in FIG. 15a and the luminance value of the pixel (luminescence area) in the first pattern is calculated. Then, luminescence are produced from the pixels in the second pattern shown in FIG. 15b and the luminance value of the pixel (luminescence area) in the second pattern is calculated. The correction parameter of each pixel is generated based on the calculated luminance value of each pixel on the display panel.

Thus, since data of the next luminescence area is hardly mixed in the luminescence area, the luminescence area can be extracted with high precision and the luminance value of the luminescence area can be calculated with high precision. In addition, an image pickup element of the digital camera whose resolution is low can be used.

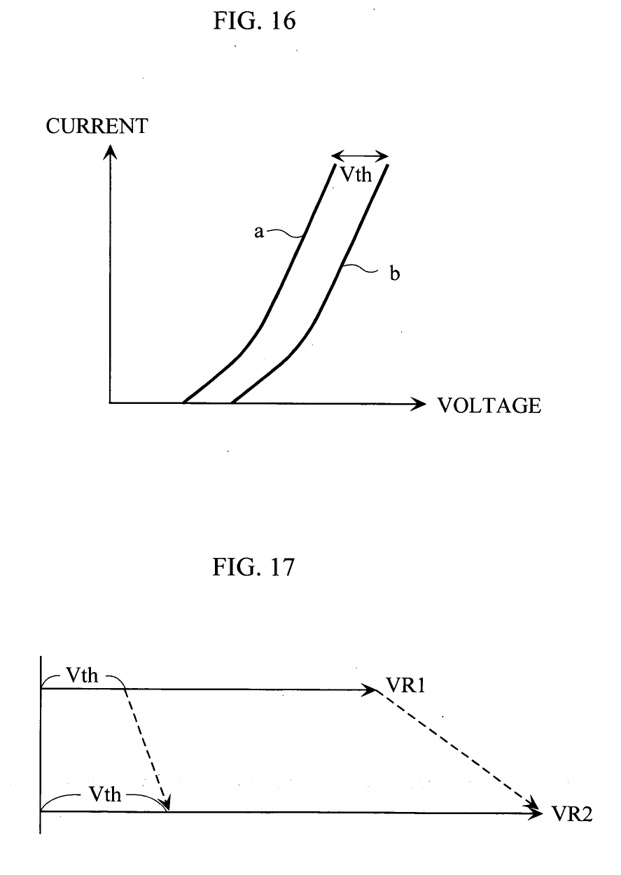

The pixels may produce luminescence in each pattern in the embodiment 2 also when the luminescence area detail mask is generated. That is, first luminescence area detail mask corresponding to the pixel in the first pattern is first generated by producing luminescence from the pixel in the first pattern shown in FIG. 16a, and then second luminescence area detail mask corresponding to the pixel in the second pattern is generated by producing luminescence from the pixel in the second pattern shown in FIG. 15b.

When the correction parameter is generated, the luminescence is first produced from the pixels in the first pattern shown in FIG. 15a, and luminescence area corresponding to the pixel in the first pattern is extracted to calculate the luminance value of the extracted luminescence area using the first luminescence area detail mask. Then, the luminescence is produced from the pixels in the second pattern shown in FIG. 15b, and luminescence area corresponding to the pixel in the second pattern is extracted to calculate the luminance values of the extracted luminescence area using the second luminescence area detail mask. The correction parameter of each pixel is generated based on the calculated luminance value of each pixel on the display panel.

In addition, as the two kinds of patterns in which all of the pixels on the display panel 11 are divided into two groups, the following patterns may be used.
(i) A first pattern comprising pixels in odd lines and a second pattern comprising pixels in even lines.
(ii) A first pattern comprising odd-numbered pixels in each line and a second pattern comprising even-numbered pixels in each line.

In addition, the pixels may be divided into three patterns comprising a first pattern consisting of R pixels, a second pattern consisting of G pixels, and a third pattern consisting of B pixels.

Meanwhile, when characteristics between voltage and current of transistors of the pixels “a” and “b” are a and b as shown in FIG. 16, respectively, the correction amount becomes Vth. As shown in FIG. 17, when the correction amount Vth is calculated by a lower white side reference voltage VR1 and then the white side reference voltage is increased to VR2 in order to increase an adjustment luminance, the correction amount Vth is also increased after the digital-analog conversion by the DAC 33.

However, as shown in FIG. 16, since the difference Vth in characteristic between the pixels “a” and “b” is almost constant regardless of the white side reference voltage, it is necessary to reduce the correction amount previously.

That is, when it is assumed that the white side reference voltage used in calculating the correction amount is VR1, the correction amount is Vth1 and the white side reference voltage after the luminance adjustment is VR2, a correction amount Vth2 after the luminance adjustment is corrected by the following equation (10).
Vth2=(VR1/VR2)×Vth1 (10)

### [C] Embodiment 3

According to the embodiments 1 and 2, in order to calculate the luminance value of each luminescence area on a display panel 11, the entire display panel 11 is taken by one shot of a digital camera 1. However, the whole display panel 11 cannot be taken by one shot of the digital camera 1 in some cases. In this case, the whole region of the display panel 11 is divided into a plurality of image pickup areas in such a manner that parts of the adjacent image pickup areas overlap each other and then images in those areas are taken by the digital camera 1. Then, the luminance value of each luminescence area on the display panel 11 is calculated based on the taken image in each image pickup area.

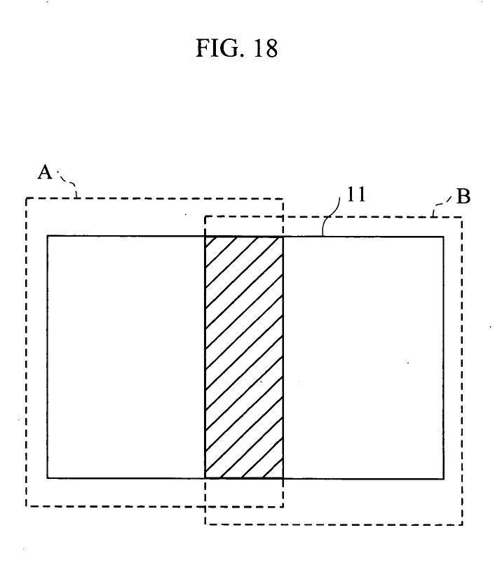

Here, as shown in FIG. 18, a description will be made in a case where the whole region on the display panel 11 is divided into two right and left image pickup areas A and B to be taken. In this case, the digital camera 1 is fixed to take the image of the area A and after the display panel 11 is shifted in the left direction, the digital camera 1 takes the image of the area B. Alternatively, the image of the area A may be taken after the image of the area B is taken.

Thus, after the display panel 11 is shot several times, variation in luminance is generated between the images because of a shift in direction of the camera 1 and the like. Thus, it is necessary to correct the variation in luminance between the images.

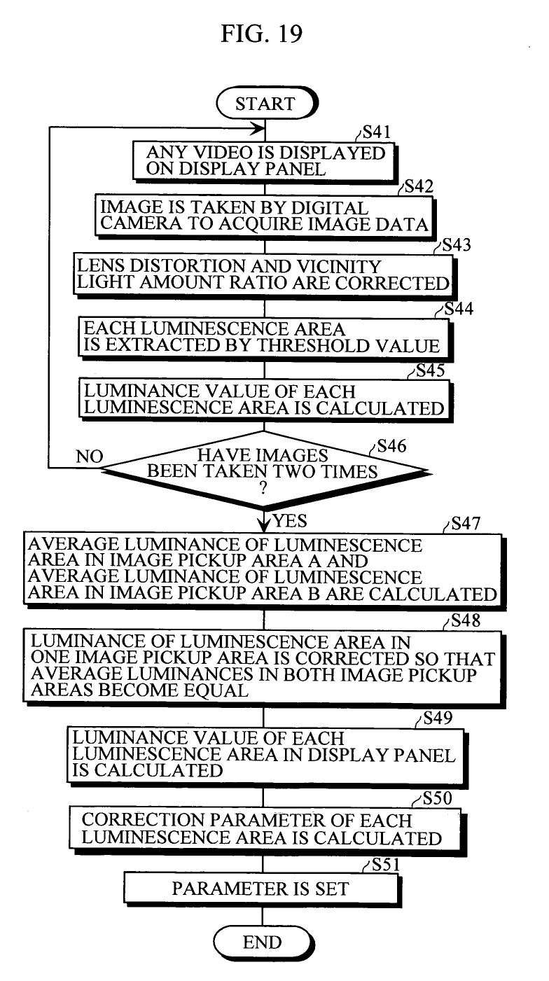

FIG. 19 shows operation procedures in which the whole region on the display panel 11 is divided into the two right and left image pickup areas A and B to be taken to generate the correction parameter from the taken image. In addition, a constitution of a device that generates the correction value for the non-uniformity of the display is the same as that shown in FIG. 5.

First, a certain input video signal whose input video signal level to each pixel of the display panel 11 is the same is input to a display 10 and its image is displayed on the display panel 11 (step S41). In this case, a PC 2 may send the input video signal to the display 10.

The image displayed on the display panel 11 is taken by the digital camera 1, so that the PC 2 can acquire the image data of the digital camera 1 (step S42). Here, as shown in FIG. 18, the area A is taken and then the area B is taken.

The PC 2 performs lens distortion correction and lens vicinity light amount ratio correction to the acquired data (image data) (step S43).

The PC 2 extracts each luminescence area (pixel) on the display panel 11 by binarizing the corrected image data using a threshold value (step S44).

The PC 2 calculates a luminance value of each luminescence area (step S45). As the luminance value of each luminescence area, a signal maximum value in the luminescence area, a signal integration value in the luminescence area, a signal average value in the luminescence area and the like are used. As the luminance value of each luminescence area, a signal integration value or a signal average value in a central region in the luminescence area or in a region around the signal maximum value may be used.

Then, it is determined whether the images have been taken two times or not (step S46). When they have not been taken two times, the display panel 11 or the camera 1 is moved and the operation returns to the step S41. Then, the operations at steps S41 to S45 are performed. Thus, as shown in FIG. 18, a luminance value of each luminescence area in the image pickup area A is found based on the first taken image and a luminance value of each luminescence area in the image pickup area B is found based on the second taken image. Since the determination at the step S46 is YES, the operation moves to step S47.

At the step S47, an average luminance in the luminescence area in the area A (referred to as the first average luminance hereinafter) and, an average luminance in the luminescence area in the area B (referred to as the second average luminance hereinafter) are calculated. Alternatively, an average luminance of the luminescence area in an overlapping part of the area A with the area B may be calculated as the first average luminance, and an average luminance of the luminescence area in an overlapping part of the area B with the area A may be calculated as the second average luminance.

Then, the luminance of the luminescence area in either one of the image pickup area A or the image pickup area B is corrected so that the first average luminance and the second average luminance becomes the same (step S48). For example, when the second average luminance is higher than the first average luminance by Δ, the luminance value of the luminescence area in the area B is reduced by Δ. The corrected luminance value of the luminescence area in the area A is set as LA (x, y), and the corrected luminance value of the luminescence area in the area B is set as LB (x, y). In addition, the above (x, y) shows the position.

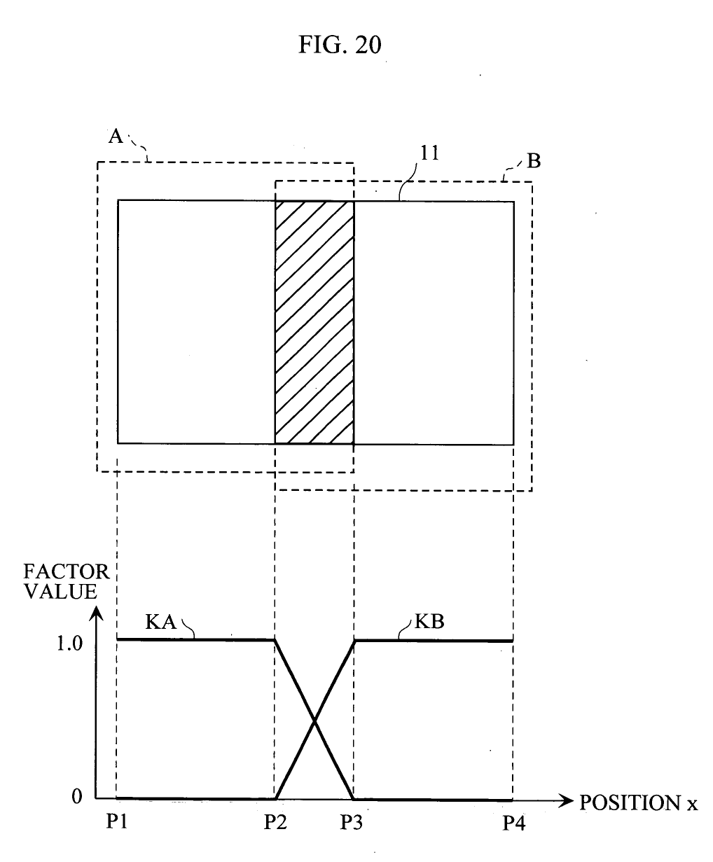

Next, a luminance value of each luminance area on the display panel 11 is found using the corrected luminance value of each luminescence area in the image pickup area A and the corrected luminance value of each luminescence area in the image pickup area B (step S49). That is, the luminance value of each luminescence area on the display panel 11 is corrected using weighted addition factors KA(x) and KB(x) for a “x” position in the horizontal direction as shown in FIG. 20. That is, the luminance value L (x, y) at the position “x” in the horizontal direction is corrected by the following equation (11).
L′(x, y)=KA(x)×LA(x, y)+KB(x)×LB(x, y) (11)

When it is assumed that P1 to P3 are in the image pickup area A and P2 to P4 are in the image pickup area B, the above equation (11) is expressed by the following equation (12).
L′(x, y)=LA(x, y) (P1≦x≦P2)
L′(x, y)=KA×LA(x, y)+KB(x)×LB(x, y) (P2<x<P3)
L′(x, y)=LB(x, y) (P3≦x≦P4) (12)

A correction parameter of each luminescence area is calculated based on the calculated luminance value L′(x, y) of each luminescence area (step S50). Since this operation is the same as that at the step S6 shown in FIG. 7, its description will be omitted.

Then, the PC 2 sets the acquired correction parameter of each luminescence area in a drive circuit 12 in the display 10 (step S51). Since this operation is the same as that at the step S7 shown in FIG. 7, its description will be omitted.

In addition, at the step S47, the average luminance of the luminescence area in the image pickup area A (first average luminance) and the average luminance of the luminescence area in the image pickup area B (second average luminance) may be calculated every horizontal line and at the step S48, the luminance of the luminescence area in either one of the image pickup area A or the image pickup area B may be corrected so that the first average luminance and the second average luminance become the same every horizontal line.

Alternatively, at the step S47, the average luminance of the luminescence area in the overlapping part of the image pickup area A with the image pickup area B (first average luminance) and the average luminance of the luminescence area in the overlapping part of the image pickup area B with the image pickup area A (second average luminance) may be calculated every horizontal line and at the step S48, the luminance of the luminescence area in either one of the image pickup area A or the image pickup area B may be corrected so that the first average luminance and the second average luminance become the same every horizontal line.

### [D] Embodiment 4

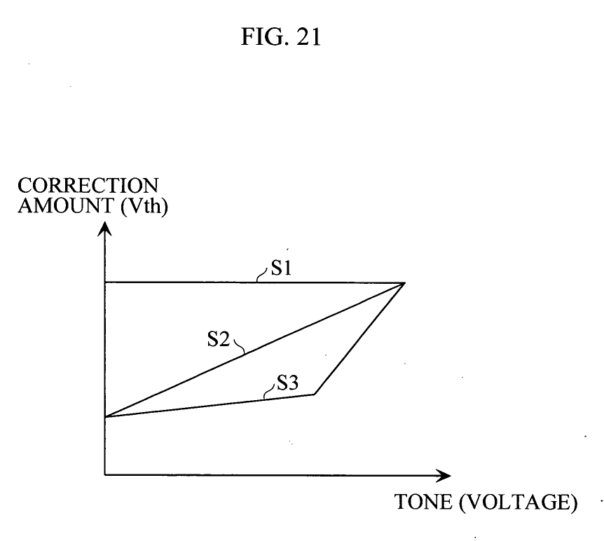

The correction parameter Vth is constant regardless of the input tone level as shown in a straight line S1 in FIG. 21 in the above embodiments 1 to 3. In fact, however, ΔVth between the characteristic “a” and characteristic “b” shown in FIG. 1 becomes large as the input tone level becomes higher in some cases. In this case, it is preferable that the correction parameter Vth is increased as the input tone level becomes higher as shown by a straight line S2 or a broken line S3 in FIG. 21.

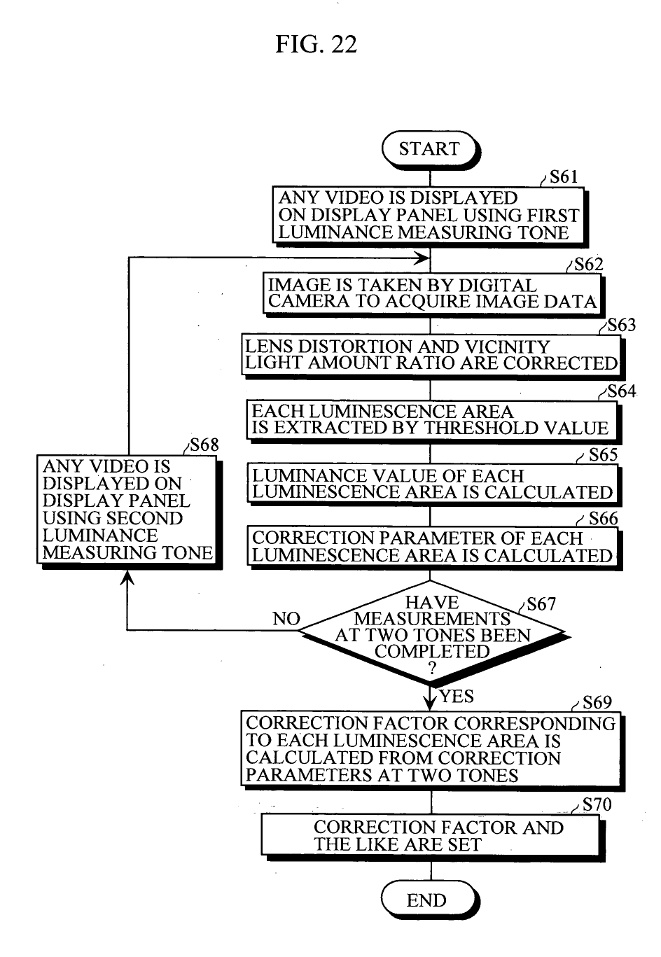

FIG. 22 shows operation procedures to find a correction factor to calculate the correction parameter Vth which changes depending on the input tone level. In addition, a constitution of a device that generates a correction value for non-uniformity of display is the same as that shown in FIG. 5.

First, an input video signal at a first luminance measuring tone Ia whose input video signal level to each pixel on a display panel 11 is the same is input to a display 10 to display its image on the display panel 11 (step S61). The first luminance measuring tone is set at 255, for example. In this case, a PC 2 may send the input video signal to the display 10.

The image displayed on the display panel 11 is taken by a digital camera 1, so that the PC 2 can acquire the image data of the digital camera 1 (step S62).

The PC 2 performs lens distortion correction and lens vicinity light amount ratio correction to the acquired data (image data) (step S63). The PC 2 extracts each luminescence area (pixel) on the display panel 11 by binarizing the corrected image data using a threshold value (step S64).

The PC 2 calculates a luminance value of each luminescence area (step S65). As the luminance value of each luminescence area, a signal maximum value in the luminescence area, a signal integration value in the luminescence area, a signal average value in the luminescence area and the like are used. As the luminance value of each luminescence area, a signal integration value or signal average value in a central region in the luminescence area or in a region around the signal maximum value may be used.

The PC 2 calculates a correction parameter corresponding to each luminescence area based on the luminance value of each luminescence area (step S66). Since this operation is the same as the step S6 shown in FIG. 7, its description will be omitted.

Next, it is determined whether measurements at the two kinds of luminance measuring tones are completed or not (step S67). When the measurements at the two kinds of luminance measuring tone is not completed, an input video signal at a second luminance measuring tone Ib (127 tone, for example) whose input video signal level to each pixel of the display panel 11 is the same is input to the display 10 and its image is displayed on the display panel 11 (step S68). Then, the operation returns to the step S62 and the operations at the steps S62 to S66 are performed. Thus, a correction parameter a(q) corresponding to each luminescence area at the first tone Ia, and a correction parameter b(q) corresponding to each luminescence area at the second tone Ib are acquired. In addition, “q” designates a position of the luminescence area. Thus, since the determination at the step S67 becomes YES, the operation proceeds to step S69.

At the step S69, correction factors A(q) and B(q) corresponding to each luminescence area are provided by the following equation (13) based on the correction parameter a (q) corresponding to each luminescence area at the first tone Ia and the correction parameter b (q) corresponding to each luminescence area at the second tone Ib.
A(q)=a(q)
B(q)={a(q)−b(q)}/(Ia−Ib) (13)

In addition, a correction amount Vth(q) at a certain tone Yin is found by the following equation (14).
Vth(q)=A(q)−{B(q)×(the luminance measuring tone at which the correction parameter a(q) is found−Yin)} (14)

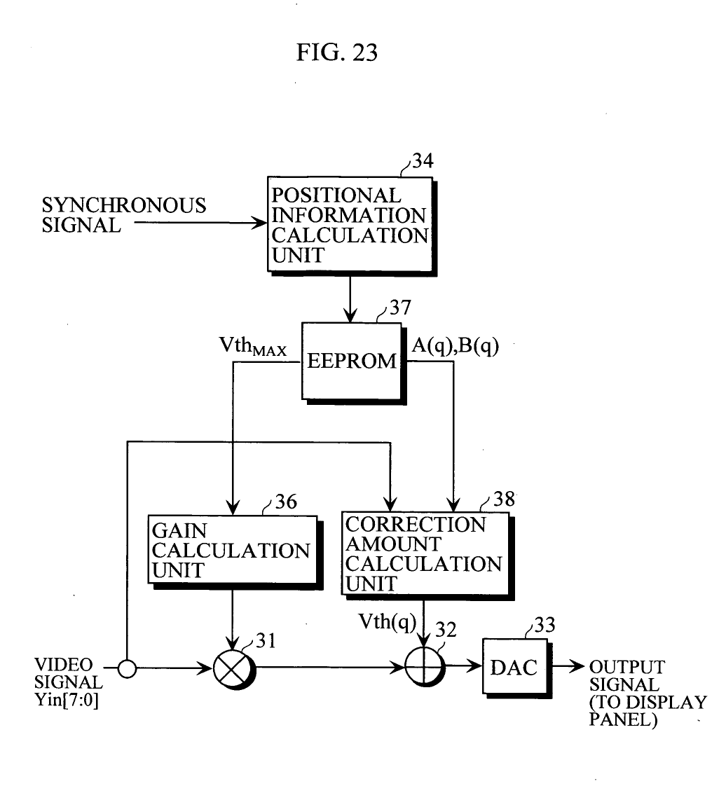

The PC 2 sets the obtained correction factors A(q) and B(q) of each luminescence area in the drive circuit 12 of the display 10 (step S70). That is, the correction factors A(q) and B(q) of each luminescence area are stored in an EEPROM 37 (refer to FIG. 23) in the drive circuit 12, and a maximum value of the correction parameter is stored therein as the Vth_{MAX}. When it is assumed that the first luminance measuring tone is 255, the maximum value of the correction parameter becomes the maximum value of the correction factor A(q). In addition, regarding the correction factor B(q), only one average value of the B(q) on the whole panel may be stored in the EEPROM 37.

FIG. 23 shows a constitution of the drive circuit (circuit that corrects the non-uniformity of the display) 12 in the display 10. In FIG. 23, the same reference numerals and signs are allotted to the same ones in FIG. 12.

The correction factors A(q) and B(q) of each luminescence area are stored in the EEPROM 37. In addition, the maximum value of the correction parameter (the maximum value of the correction factor A(q) when the first tone is 255) is stored in the EEPROM 37 as the Vth_{MAX}. A description will be made assuming that the first tone is 255 hereinafter.

The input video signal Yin is sent to the display panel (organic EL panel) 11 through a multiplier 31 to perform a step width changing operation of the input video signal, an adder 32 to perform a shift operation to an output of the adder 31, and a DAC 33 to convert an output of the adder 32 to an analog signal. The input video signal Yin is sent also to a correction amount calculation unit 38.

The maximum value Vth_{MAX} of the correction parameter is sent from the EEPROM 37 to a gain calculation unit 36. The gain calculation unit 36 calculates a gain based on the following equation (15) and applies the calculated gain to the multiplier 31.

$$gain = \frac{255 - {Vth}_{MAX}}{255} \qquad ( 15 )$$

A synchronous signal contained in the input video signal is sent to a positional information calculation unit 34. The positional information calculation unit 34 calculates positional information (xq, yq) of the video signal being inputted at present (video signal of a target pixel) based on the synchronous signal.

The positional information (xq, yq) of the target pixel calculated by the positional information calculation unit 34 is applied to the EEPROM 37. The correction factors A(q) and B(q) corresponding to the luminescence area (target pixel) shown by the positional information (xq, yq) are read from the EEPROM 37 and sent to a correction amount calculation unit 38.

The correction amount calculation unit 38 calculates a correction amount Vth(q) corresponding to that luminescence area (target pixel) based on the following equation (16).
Vth(q)=A(q)−{B(q)×(255−Yin)} (16)

The correction amount Vth(q) calculated by the correction amount calculation unit 38 is applied to the adder 32.

The multiplier 31 multiplies the input video signal Yin by the gain. An output of the multiplier 31 is sent to the adder 32. The adder 32 adds the shift amount Vth(q) to the output of the multiplier 31. An output of the adder 32 is sent to the DAC 33 and converted to the analog signal Yout and sent to the display panel 11.

Although the correction amount which changes depending on the input tone is calculated from the correction parameters at any two kinds of luminance measuring tones in the above embodiment 4, the correction amount which changes depending on the input tone may be calculated from the correction parameters at any three kinds or more of luminance measuring tones.

For example, when the correction amount which changes depending on the input tone is calculated from the correction parameters at any three kinds of luminance measuring tones, correction parameters a(q), b(q), and c(q) corresponding to each luminescence area at any three tones are found by the same operation as that shown in FIG. 22.

When it is assumed that the correction parameter at the greatest tone is a(q), the correction parameter at the middle tone is b(q) and the correction parameter at the smallest tone is c(q), A1(q) and B1(q) are calculated from the b(q) and the c(q) by the same calculating method as in the equation (13) and A2(q) and B2(q) are calculated from the a(q) and the b(q) by the same calculating method as in the equation (13).

Then, the correction amount Vth(q) is calculated based on the A1(q) and B1(q) at the tone not more than the middle tone, and the correction amount Vth(q) is calculated based on the A2(q) and B2(q) at the tone not less than the middle tone.

1. A device that generates a correction value for non-uniformity of display comprising:
image taking means for taking an image displayed on a display panel on which the non-uniformity of the display is to be corrected; and
correction value calculating means for generating the correction value for the non-uniformity of the display with respect to each luminescence area on the display panel based on the image taken by the image taking means in a state all pixels on the display panel produce luminescence.

2. The device that generates the correction value for the non-uniformity of the display according to claim 1, wherein
the correction value calculating means comprises:
first means for extracting each luminescence area on the display panel based on the image taken by the image taking means;
second means for calculating a luminance value of the extracted each luminescence area based on the image taken by the image taking means, and third means for calculating the correction value for the non-uniformity of the display with respect to each luminescence area based on the calculated luminance value of each luminescence area.

3. The device that generates the correction value for the non-uniformity of the display according to claim 2, wherein the third means sets one luminescence area as a reference luminescence area and calculates the correction value for the non-uniformity of the display of each luminescence area from a value corresponding to a difference in luminescence start tone level between the luminescence area and the reference luminescence area, based on a luminous efficiency characteristic of any luminescence area and the luminance value of each luminescence area calculated by the second means.

4. The device that generates the correction value for the non-uniformity of the display according to claim 1, wherein the image taking means is implemented by a digital camera and the correction value calculating means is implemented by a PC.

5. A device that generates a correction value for non-uniformity of display comprising:
image taking means for taking an image displayed on a display panel on which the non-uniformity of the display is to be corrected;
in a state where all pixels on the display panel are divided into a plurality of groups and only the pixels belonging to one group produce luminescence with respect to each group, luminance value calculating means for calculating a luminance value of each luminescence area corresponding to a pixel belonging to the group, based on an image taken by the image taking means from the image on the display panel; and
correction value calculating means for generating the correction value for the non-uniformity of the display with respect to each pixel on the display panel, based on the luminance value of the luminescence area corresponding to each pixel on the display panel which is calculated by the luminance value calculating means.

6. The device that generates the correction value for the non-uniformity of the display according to claim 5, wherein the luminance value calculating means comprises:
first means for extracting the luminescence area corresponding to each pixel belonging to each of the groups, based on the image taken by the image taking means in the state where only the pixels belonging to one group produce luminescence with respect to each group; and
second means for calculating the luminance value in the luminescence area corresponding to each pixel belonging to the group extracted by the first means, based on the image taken by the image taking means in the state where only the pixels belonging to the group produce luminescence.

7. The device that generates the correction value for the non-uniformity of the display according to claim 5, wherein the correction value calculating means sets one luminescence area as a reference luminescence area and calculates the correction value for the non-uniformity of the display of each luminescence area from a value corresponding to a difference in luminescence start tone level between the luminescence area and the reference luminescence area, based on a luminous efficiency characteristic of any luminescence area and the luminance value of the luminescence area corresponding to each pixel on the display panel, which is calculated by the luminance value calculating means.

8. The device that generates the correction value for the non-uniformity of the display according to claim 5, wherein the image taking means is implemented by a digital camera, and the luminance value calculating means and the correction value calculating means are implemented by a PC.

9. The device that generates the correction value for the non-uniformity of the display according to claim 5, wherein all of the pixels on the display panel are divided into a first group comprising odd-numbered pixels in odd lines and even-numbered pixels in even lines, and a second group comprising even-numbered pixels in odd lines and odd-numbered pixels in even lines.

10. A device that generates a correction value for non-uniformity of display comprising:
image taking means for taking an image displayed on a display panel on which the non-uniformity of the display is to be corrected, and
correction value calculating means for calculating the correction value for the non-uniformity of the display with respect to each luminescence area on the display panel, by dividing the entire region on the display panel into a plurality of image pickup areas so that parts of the adjacent image pickup arrears overlap each other and taking images on those areas by the image taking means, based on the image of each image pickup area, in a state all of the pixels on the display panel produce luminescence.

11. The device that generates the correction value for the non-uniformity of the display according to claim 10, wherein the correction value calculating means comprises:
first means for calculating a luminance value of each luminescence area on the display panel in the image pickup area based on the image of the image pickup area with respect to each image pickup area;
second means for calculating an average luminance value of each luminescence area in the image pickup area with respect to each image pickup area;
third means for correcting variation in luminance of each luminescence area between the image pickup areas, based on the average luminance of each luminescence area in each image pickup area calculated by the second means;
fourth means for calculating a luminance value of each luminescence area in a part of the image pickup area overlapping the adjacent area by a weighted addition method, based on the luminance value of each luminescence area of each image pickup area corrected by the third means;
fifth means for finding each luminance value on the display panel by setting the luminance value corresponding to the luminescence area corrected by the third means as the luminance value of the luminescence area in a region which does not overlap the adjacent image pickup area, and by setting the luminance value calculated by the fourth means as the luminance value of the luminescence area in the region which overlaps the adjacent image pickup area; and
sixth means for calculating the correction value of the non-uniformity of the display of each luminescence area based on the luminance value of the luminescence area calculated by the fifth means.

12. The device that generates the correction value for the non-uniformity of the display according to claim 11, wherein the sixth means sets one luminescence area as a reference luminescence area and calculates the correction value for the non-uniformity of the display of each luminescence area from a value corresponding to a difference in luminescence start tone level between the luminescence area and the reference luminescence area, based on a luminous efficiency characteristic of any luminescence area and the luminance value of each luminescence area calculated by the fifth means.

13. The device that generates the correction value for the non-uniformity of the display according to claim 10, wherein the image taking means is implemented by a digital camera and the correction value calculating means is implemented by a PC.

14. A device that generates a correction value for non-uniformity of display comprising:
image taking means for taking an image displayed on a display panel on which the non-uniformity of the display is to be corrected;
first means for performing an operation in which luminescence is produced from all pixels on the display panel uniformly at a certain tone (luminance measuring tone) and the image displayed on the display panel is taken by the image taking means, with respect to each of plural kinds of luminescence measuring tones;
second means for calculating a luminance value of each luminescence area on the display panel based on the image taken at each luminance measuring tone;
third means for calculating the correction value for the non-uniformity of the display with respect to each luminescence area taken at each luminance measuring tone, based on the luminance value of each luminescence area on the display panel calculated by the second means taken at each luminance measuring tone; and
fourth means for calculating a parameter to calculate the correction value of the non-uniformity of the display for an input tone with respect to each luminescence area, based on the correction value for the non-uniformity of the display of each luminescence area calculated by the third means taken at each luminance measuring tone.

15. The device that generates the correction value for the non-uniformity of the display according to claim 14, wherein the third means sets one luminescence area as a reference luminescence area and calculates the correction value for the non-uniformity of the display of each luminescence area from a shift amount to shift the input tone of each luminescence area so that the luminance value of each luminescence area may become equal to the luminance value of the reference luminescence area at each luminance measuring tone, based on a luminous efficiency characteristic of any luminescence area and the luminance value of each luminescence area calculated by the second means.

16. The device that generates the correction value for the non-uniformity of the display according to claim 14, wherein the image taking means is implemented by a digital camera and the first to fourth means are implemented by a PC.
